(19) United States
(12) Patent Application Publication
(10) Pub. No.: US 2016/0286636 A1
(43) Pub. Date: Sep. 29, 2016

(54) HIGH-VOLTAGE GENERATOR AND X-RAY SCANNING APPARATUS THEREWITH

(71) Applicant: HITACHI , LTD., Tokyo (JP)

(72) Inventors: Mina OGAWA, Tokyo (JP); Hiroshi TAKANO, Tokyo (JP)

(73) Assignee: HITACHI, LTD., Tokyo (JP)

(21) Appl. No.: 15/035,379

(22) PCT Filed: Nov. 13, 2014
(86) PCT No.: PCT/JP2014/080022

§ 371 Date: May 9, 2016

(30) Foreign Application Priority Data
Nov. 26, 2013 (JP) 2013-243662

(51) Int. Cl. H05G 1/32

(52) U.S. Cl. CPC H05G 1/32

(57) ABSTRACT

In order to provide a high-voltage generator having a high-voltage transformer miniaturized while insulation between secondary windings and an iron core is maintained, the present invention is characterized by that the high-voltage transformer having a primary winding, the secondary windings, and the iron core as well as a high-voltage rectifier rectifying an alternating current voltage to be output from the high-voltage transformer into a direct current voltage are comprised, that the secondary windings and the iron core are divided in the direction of a magnetic flux generated by applying an alternating current to the primary winding, that the respective divided secondary windings are wound around the respective divided iron cores correspondingly, and that dielectrics are disposed between the respective divided iron cores.

### TECHNICAL FIELD

The present invention relates to an X-ray scanning apparatus that performs X-ray scanning and, in particular, to a technique for miniaturizing a high-voltage transformer in an X-ray high-voltage device for the X-ray scanning apparatus.

### BACKGROUND ART

The X-ray scanning apparatus generates and displays an X-ray image of an object based on a transmitted X-ray dose obtained by irradiating X-rays to the object. In particular, an apparatus that reconstructs and displays sectional images of the object based on a transmitted X-ray dose obtained by irradiating X-rays at various angles from the circumference of the object is referred to as an X-ray CT (Computed Tomography) apparatus.

For such an X-ray scanning apparatus, needs to reduce the installation area and miniaturize and lighten the apparatus have arisen. A ratio of the high-voltage transformer in the X-ray high-voltage device that is a component of the X-ray scanning apparatus to the apparatus volume is high, and miniaturizing the high-voltage transformer is effective to miniaturize the entire apparatus. The high-voltage transformer is an electric appliance that uses electromagnetic induction to convert an alternating current voltage level. When the high-voltage transformer is used for the X-ray high-voltage device, it converts an input voltage into a higher voltage of approximately 100 to 140 kV for example. That is, an insulation distance needs to be provided for a secondary winding of the high-voltage transformer, which requires ingenuity for miniaturization. In particular, because it is desirable to expand an opening more to accommodate an object in the X-ray CT apparatus, miniaturizing the high-voltage transformer is important.

The patent literature 1 discloses that a main transformer has a plurality of secondary windings and voltage doubler rectifying circuits are connected to each of them in order to generate a higher voltage by connecting these voltages in series.

### CITATION LIST

### Patent Literature

PTL 1: Japanese Unexamined Patent Publication No. 2003-244957

### SUMMARY OF INVENTION

### Technical Problem

However, since a high voltage is generated between the secondary windings and an iron core that is generally a ground voltage even in a case of the configuration having a plurality of secondary windings similarly to PTL 1, it is difficult to miniaturize a high-voltage transformer considering insulation distances between the iron core and the secondary windings.

Here, the purpose of the present invention is to provide a high-voltage generator having a high-voltage transformer miniaturized while insulation between secondary windings and an iron core is maintained and an X-ray scanning apparatus therewith.

### Solution to Problem

In order to achieve the above purpose, the present invention comprises a high-voltage transformer that has a primary winding, secondary windings, and an iron core as well as a high-voltage rectifier that rectifies an alternating current voltage to be output from the high-voltage transformer into a direct current voltage and is characterized by that the secondary windings and the iron core are divided in the direction of a magnetic flux generated by applying an alternating current to the primary winding; that the respective divided secondary windings are wound around the respective divided iron cores correspondingly; and that dielectrics are disposed between the respective divided iron cores.

Also, the present invention is an X-ray scanning apparatus that comprises an X-ray source irradiating an X-ray to an object and an X-ray high-voltage device supplying electric power to the X-ray source and is characterized by that the X-ray high-voltage device comprises a high-voltage transformer that has a primary winding, secondary windings, and an iron core as well as a high-voltage rectifier that rectifies an alternating current voltage to be output from the high-voltage transformer into a direct current voltage; that the secondary windings and the iron core are divided in the direction of a magnetic flux generated by applying an alternating current to the primary winding; that the respective divided secondary windings are wound around the respective divided iron cores correspondingly; and that dielectrics are disposed between the respective divided iron cores.

### Advantageous Effects of Invention

The present invention can provide a high-voltage generator having a high-voltage transformer miniaturized while insulation between secondary windings and an iron core is maintained and an X-ray scanning apparatus therewith.

### BRIEF DESCRIPTION OF DRAWINGS

FIG. 1 is a block diagram showing the overall configuration of an X-ray CT apparatus of the present invention.

FIG. 2 is a block diagram showing the configuration of an X-ray controller of the present invention.

FIG. 3 is a wiring diagram of the high-voltage generator of a first embodiment.

FIG. 4 is a configuration diagram of the high-voltage transformer of the first embodiment.

FIG. 5 is a configuration diagram of the high-voltage transformer of a second embodiment.

FIG. 6 is a configuration diagram of the high-voltage generator of a third embodiment.

FIG. 7 is a wiring diagram of the high-voltage transforming device of a fourth embodiment.

FIG. 8 is a configuration diagram of the high-voltage transformer of the fourth embodiment.

FIG. 9 is a configuration diagram of the high-voltage transformer of a fifth embodiment.

FIG. 10 is a configuration diagram of the high-voltage transformer of a sixth embodiment.

FIG. 11 is a configuration diagram of the high-voltage transformer of a seventh embodiment.

FIG. 12 is a configuration diagram of the high-voltage transformer of an eighth embodiment.

FIG. 13 is a configuration diagram of the high-voltage transformer of a ninth embodiment.

FIG. 14 is a perspective view of an essential part of the high-voltage transformer of a tenth embodiment.

FIG. 15 is a cross-sectional view of FIG. 14.

FIG. 16 is a configuration diagram of the high-voltage transformer of an eleventh embodiment.

### DESCRIPTION OF EMBODIMENTS

Hereinafter, desirable embodiments of the present invention will be described according to the attached drawings. Additionally, in the following descriptions and the attached drawings, the same reference signs are used for components having the same functions, and the repeated explanations are omitted.

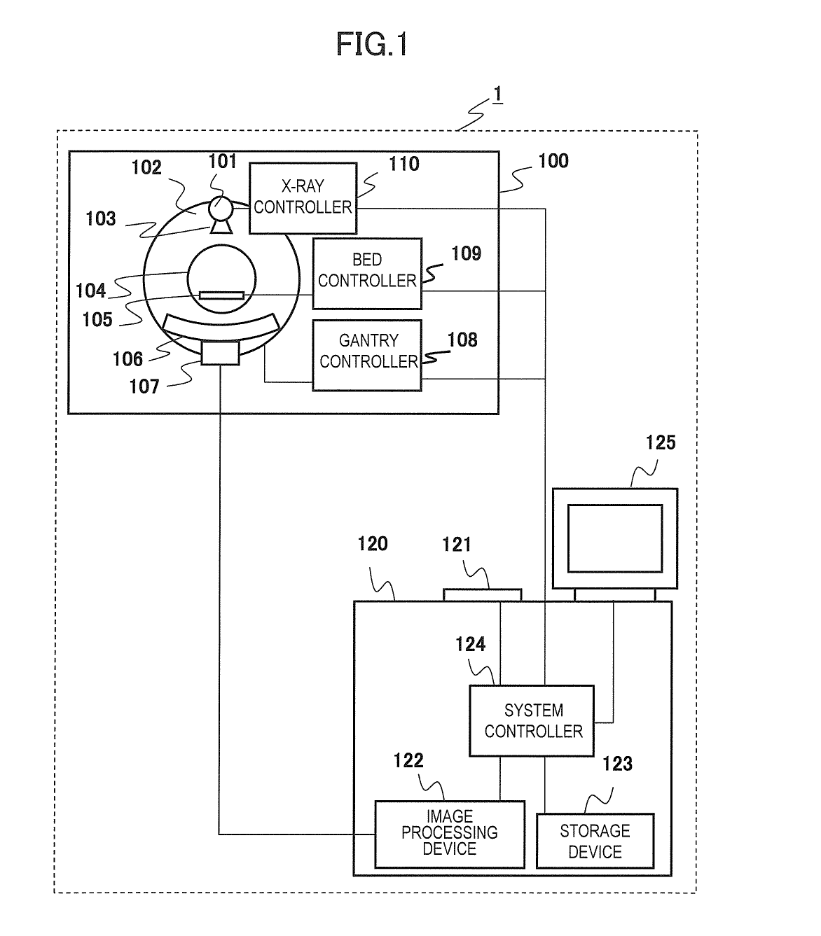

FIG. 1 is a block diagram showing the overall configuration of the X-ray CT apparatus that is an example of an X-ray scanning apparatus. An X-ray CT apparatus 1 comprises a scan gantry unit 100 and an operation unit 120 as shown in FIG. 1.

The scan gantry unit 100 comprises an X-ray tube device 101, a rotary disk 102, a collimator 103, an X-ray detector 106, a data collection device 107, a bed device 105, a gantry controller 108, a bed controller 109, and an X-ray controller 110. The X-ray tube device 101 irradiates an X-ray to an object placed on the bed device 105 and becomes an X-ray source. The collimator 103 limits a radiation range of an X-ray to be irradiated from the X-ray tube device 101.

The rotary disk 102 comprises an opening 104 to accommodate the object placed on the bed device 105, is equipped with the X-ray tube device 101 and the X-ray detector 106, and rotates around the object. The X-ray detector 106 measures a spatial distribution of transmitted X-rays by detecting the X-rays transmitted through the object disposed opposite to the X-ray tube device 101, and a number of detection elements are arranged one-dimensionally in the rotational direction of the rotary disk 102 or two-dimensionally in the rotational and rotation-axis directions of the rotary disk 102 in the X-ray detector 106.

The data collection device 107 collects X-ray doses detected by the X-ray detector 106 as digital data. The gantry controller 108 controls rotation and inclination of the rotary disk 102. The bed controller 109 controls vertical, horizontal, and anteroposterior movements of the bed device 105. The X-ray controller 110 controls an electric power to be input to the X-ray tube device 101. The X-ray controller 110 will be described in detail later.

The operation unit 120 comprises an input device121, an image processing device 122, a display device 125, a storage device 123, and a system controller 124. The input device121 is a device for inputting an object name, an examination date, scanning conditions, and the like. Specifically, the input device121 is a keyboard, a pointing device, a touch panel, or the like. The image processing device 122 performs arithmetic processing for measurement data to be sent out of the data collection device 107 to reconstruct CT images. The display device 125 displays the CT images and the like generated by the image processing device 122. Specifically, the display device 125 is a CRT (Cathode-Ray Tube), a liquid crystal display, or the like. The storage device 123 stores data collected by the data collection device 107, image data of the CT images generated by the image processing device 122, and the like. Specifically, the storage device 123 is an HDD (Hard Disk Drive) or the like. The system controller 124 controls these devices, the gantry controller 108, the bed controller 109, and the X-ray controller 110.

The X-ray tube device 101 irradiates an X-ray to an object according to the scanning conditions by that the X-ray controller 110 controls an electric power to be input to the X-ray tube device 101 based on the scanning conditions such as an X-ray tube voltage and an X-ray tube current that were input from the input device121. The X-ray detector 106 detects an X-ray irradiated from the X-ray tube device 101 and transmitted through the object with a number of X-ray detection elements in order to measure a transmitted X-ray distribution. The rotary disk 102 is controlled by the gantry controller 108 and rotates based on the scanning conditions such as a rotational speed input from the input device121. The bed device 105 is controlled by the bed controller 109 and operates based on the scanning conditions such as a helical pitch input from the input device 121.

By repeating X-ray irradiation from the X-ray tube device 101 and measuring transmitted X-ray distribution by the X-ray detector 106 with rotation of the rotary disk 102, projection data from various angles is acquired. The projection data is associated with a view showing each angle, a channel (ch) number that is a detection element number of the X-ray detector 106, and a row number. The projection data acquired from various angles is transmitted to the image processing device 122. The image processing device 122 reconstructs CT images by performing back projection processing for the transmitted projection data from various angles. The CT images acquired by the reconstruction are displayed on the display device 125.

Additionally, the X-ray CT apparatus 1 may be connected to severs inside and outside a hospital via a network that is not shown in the drawings and may load necessary data from each server as needed.

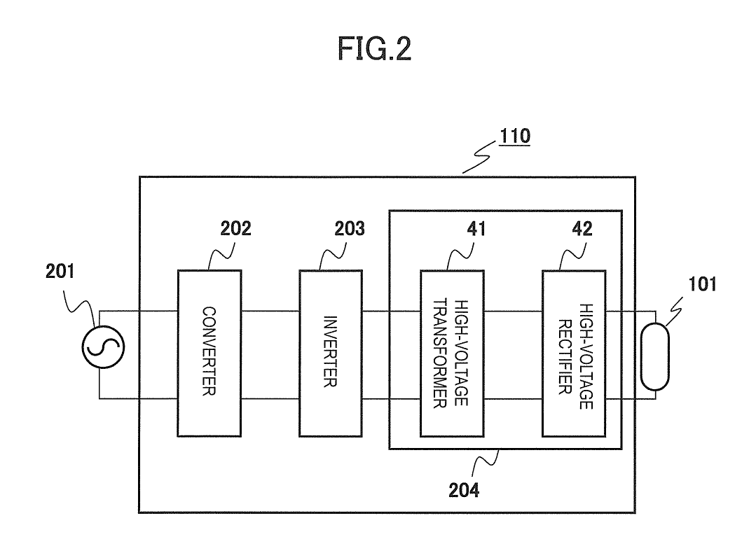

The X-ray controller 110 will be described using FIG. 2. The X-ray controller 110 comprises a converter 202, an inverter 203, and a high-voltage transformer 41, and a high-voltage rectifier 42. The converter 202 is connected to an alternating current power source 201 and converts an alternating current voltage of the alternating current power source 201 into a direct current voltage. The inverter 203 is connected to the converter 202 and converts a direct current voltage to be output from the converter 202 into the alternating current voltage.

An alternating current voltage to be output from the inverter 203 has a frequency higher than an alternating current voltage to be output from the alternating current power source 201. The high-voltage transformer 41 is connected to the inverter 203 boosts the alternating current voltage to be output from the inverter 203. The high-voltage rectifier 42 is connected to the high-voltage transformer 41 and rectifies an alternating current voltage boosted by the high-voltage rectifier 42 into a direct current voltage. Output terminals of the high-voltage rectifier 42 are connected to the X-ray tube device 101, and an X-ray is irradiated from the X-ray tube device 101 by that an alternating current voltage to be output from the high-voltage rectifier 42 is applied to the X-ray tube device 101.

Additionally, the high-voltage transformer 41 and the high-voltage rectifier 42 are collectively referred to as a high-voltage generator 204. In the X-ray controller 110, at least the high-voltage generator 204 should be mounted on the rotary disk 102, and the converter 202 as well as the inverter 203 may be or may not be mounted on the rotary disk 102.

### First Embodiment

Detailed configuration of the high-voltage transformer 41 that is an essential part of the present invention and the surrounding will be described.

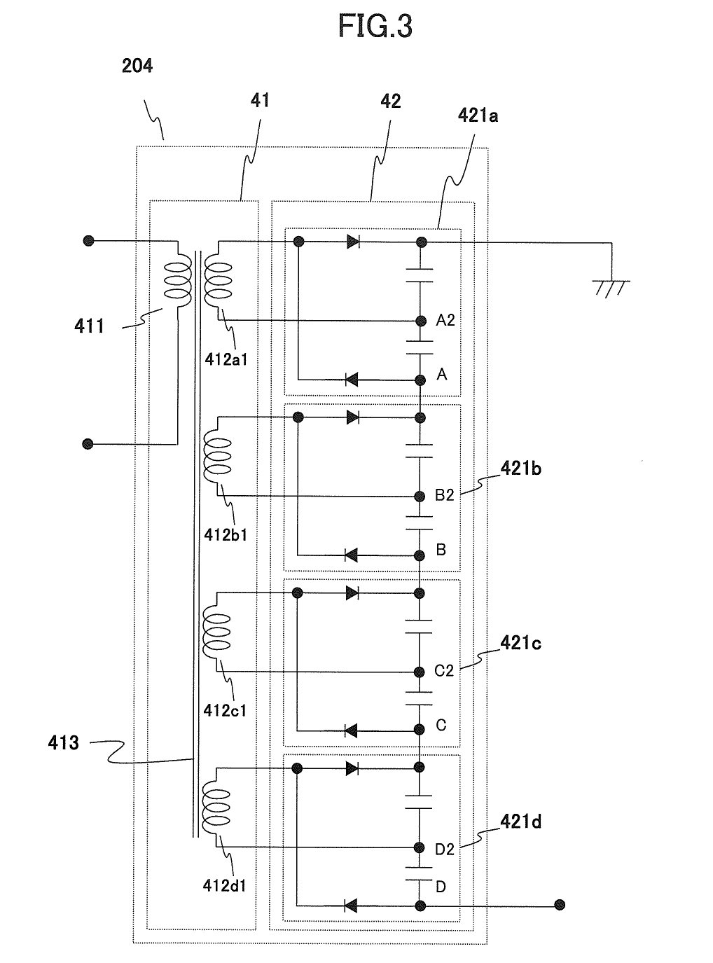

Using FIG. 3, a wiring configuration inside the high-voltage generator 204 will be described. The high-voltage transformer 41 has a primary winding 411, a plurality of secondary windings 412a1 to 412d1, and an iron core 413. A plurality of the secondary windings 412a1 to 412d1 have the same number of windings and are respectively connected to voltage doubler rectifying circuits 421a to 421d of the high-voltage rectifier 42. Voltages to be output from the voltage doubler rectifying circuits 421a to 421d respectively is direct current voltages corresponding to twice alternating current voltages to be output from the respective secondary windings 412a1 to 412d1. A plurality of outputs of the voltage doubler rectifying circuits 421a to 421d are connected in series, and one of the output terminals of the high-voltage rectifier 42 are set as a ground potential.

Additionally, a high-voltage generator to be used for a so-called neutral point grounding type of X-ray tube device may be used by setting one potential as V and the other potential as −V in a case where a potential difference between both the terminals of the high-voltage rectifier 42 is 2V. Also, a wiring configuration of the high-voltage rectifier 42 is not limited to the example of FIG. 3.

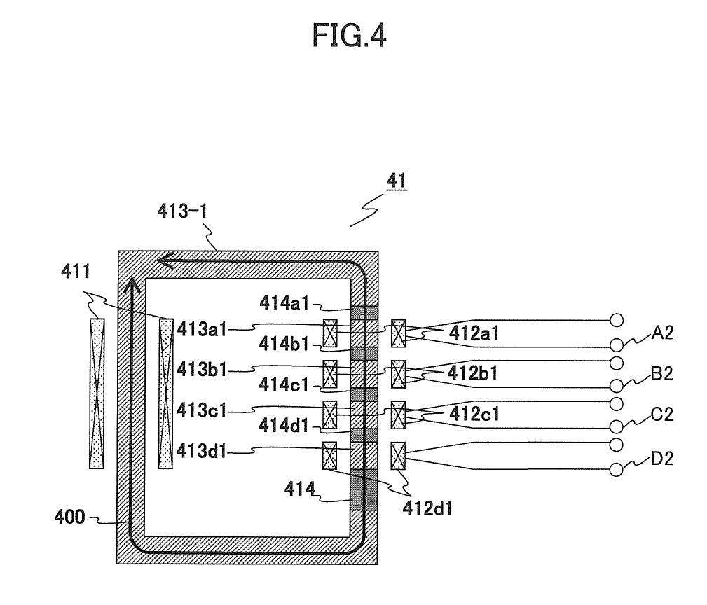

FIG. 4 is a cross-sectional schematic view showing the structure of the high-voltage transformer 41 of the present embodiment. The primary winding 411 and a plurality of the secondary windings 412a1 to 412d1 are wound around the iron core 413. By applying an alternating current to the primary winding 411, a varying magnetic flux in a direction of an arrow 400 is generated in the iron core 213. The generated varying magnetic flux causes electromagnetic induction and generates a voltage, at which a ratio of the number of windings between the primary winding and the respective secondary windings was multiplied by a voltage applied to the primary winding, to each of the secondary windings 412a1 to 412d1.

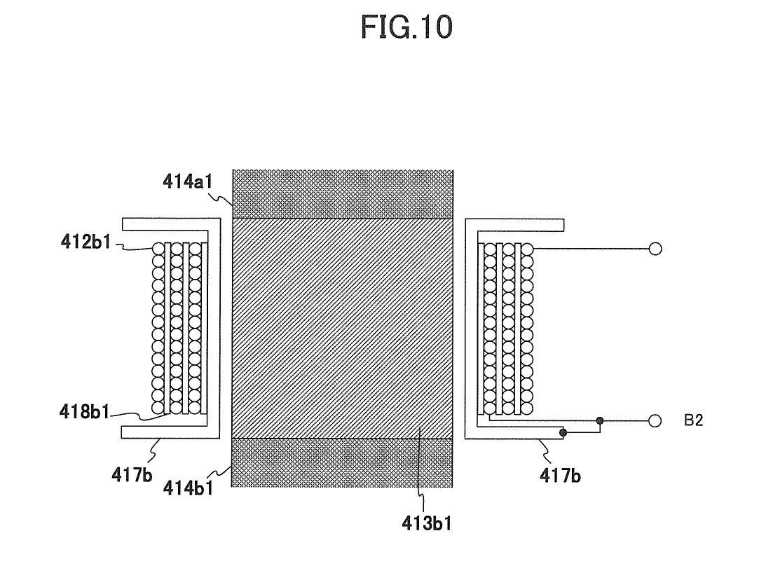

The present embodiment is characterized by that the iron core 413 has a shape in which approximately U-shaped iron cores are assembled facing each other and one leg of the iron core 413 is divided in the magnetic flux direction. The primary winding 411 is wound around a leg 413-1 of the iron core 413 on the undivided side, and the secondary windings 412a1 to 412d1 are wound around legs 413a1 to 413d1 on the divided side. In most cases, the iron core 413-1 is a ground potential, which is similar also to the present embodiment. The secondary windings 412a1 to 412d1 are wound around the divided iron cores 413a1 to 413d1 respectively. Additionally, the secondary windings 412a1 to 412d1 are not directly wound around the divided iron cores 413a1 to 413d1 but wound around the iron cores 413a1 to 413d1 respectively with bobbins to be described later. The bobbins of the present embodiment are insulators having a shape shown in FIG.10.

Next, a potential of each divided iron core will be described. First, a potential of a voltage doubler rectifying circuit will be described. For example, in order to set an output voltage of the high-voltage generator 204 shown in FIGS. 3 to −140 kV, each of the voltage doubler rectifying circuits 421a to 421d should generate 35 kV because the secondary windings and the voltage doubler rectifying circuits of the present embodiment of the high-voltage transformer 41 of the present embodiment are divided into four portions. Also, output terminals of the voltage doubler rectifying circuits 421a to 421d are connected in series, and a reference potential to ground potentials of the voltage doubler rectifying circuits 421a to 421d is different for each 35 kV. Specifically, the potentials are −35 kV at the point A, −70 kV at the point B, −105 kV at the point C, and −140 kV at the point D.

The divided iron cores 413a1 to 413d1 of FIG. 4 are electrically connected to nowhere, which results in that the potentials float and become almost equivalent to the secondary windings 412a1 to 412d1 that are closest thereto.

That is, potential differences between the divided iron cores 413a1 to 413d1 and the secondary windings 412a1 to 412d1 wound around the iron cores 413a1 to 413d1 respectively are reduced compared to a case where the iron cores are not divided, which enables the iron cores 413 and the secondary windings 412 to approach each other.

Additionally, the divided iron cores 413a1 to 413d1 have different potentials according to the corresponding secondary windings 412a1 to 412d1, and the iron core 413-1 is a ground potential, which cause potential differences between the divided iron cores. In the present embodiment, the potential differences between the iron core 413-1 and the iron core 413a1, between the iron core 413a1 and the iron core 413b1, between the iron core 413b1 and the iron core 413c1, as well as between the iron core 413c1 and the iron core 413d1 are equal, and the potential difference between the iron core 413-1 and the iron core 413d1 is four times as great as the potential difference between the other iron cores. In order to electrically insulate these potential differences, dielectrics 414 and 414a1 to 414d1 are disposed between the respective iron cores. Sizes and materials of the dielectrics 414 and 414a1 to 414d1 should be appropriately determined according to the potential difference between iron cores. For example, insulating oil, Mylar sheets, PTFE (PolyTetraFluoroEthlene), and the like are used as the dielectrics. In a case where the materials of the dielectrics 414 and 414a1 to 414d1 are the same, the size of the dielectric 414 is four times as large as the other dielectrics 414a1 to 414d1.

Also, using a high resistor like PTFE as a dielectric can stabilize a potential of each iron core, and electric fields are uniformly changed in the high-voltage transformer 41, which can reduce risk of insulation breakdown due to electric field concentration.

As described above, because the iron cores 413 and the secondary windings 412 can approach each other compared to a case where the iron core 413 is not divided according to the configuration of the present embodiment, this can provide a high-voltage generator having a high-voltage transformer miniaturized while insulation between the iron core and secondary windings is maintained and an X-ray scanning apparatus therewith.

### Second Embodiment

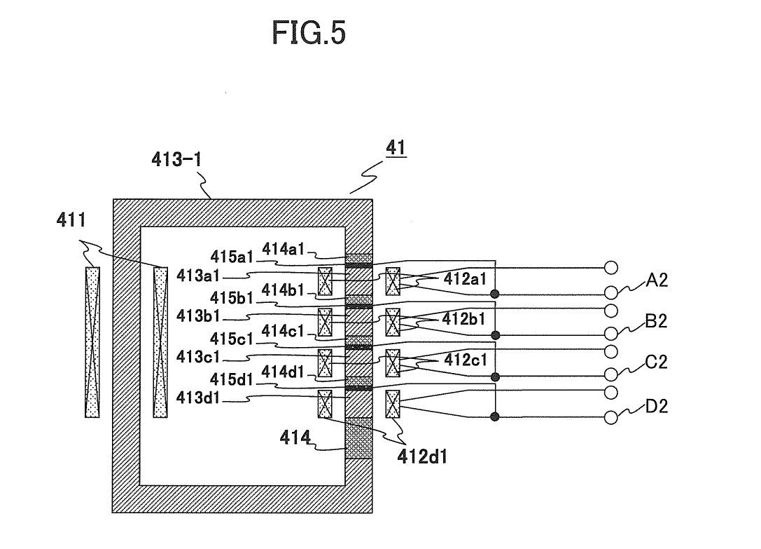

The second embodiment will be described using FIG. 5. A difference from the first embodiment is that it is configured so as to have the same potential between one terminals of the respective divided secondary windings and the respective divided iron cores. Hereinafter, the difference from the first embodiment will be described mainly.

Electrodes 415a1 to 415d1 are provided on a cross section orthogonal to the magnetic flux direction of the divided iron cores 413a1 to 413d1, and the electrodes 415a1 to 415d1 are electrically connected to one terminals A2 to D2 of the secondary windings 412a1 to 412d1. Therefore, each of the electrodes 415a1 to 415d1 and the divided iron cores 413a1 to 413d1 has the same potential as the one terminals A2 to D2 of the secondary windings 412a1 to 412d1, and potentials of the divided iron cores 413a1 to 413d1 are prevented from floating. Consequently, even in a transitional state such as when the X-ray controller 111 is started up, electric fields are uniformly changed in the high-voltage transformer 41, which can reduce risk of insulation breakdown due to electric field concentration.

### Third Embodiment

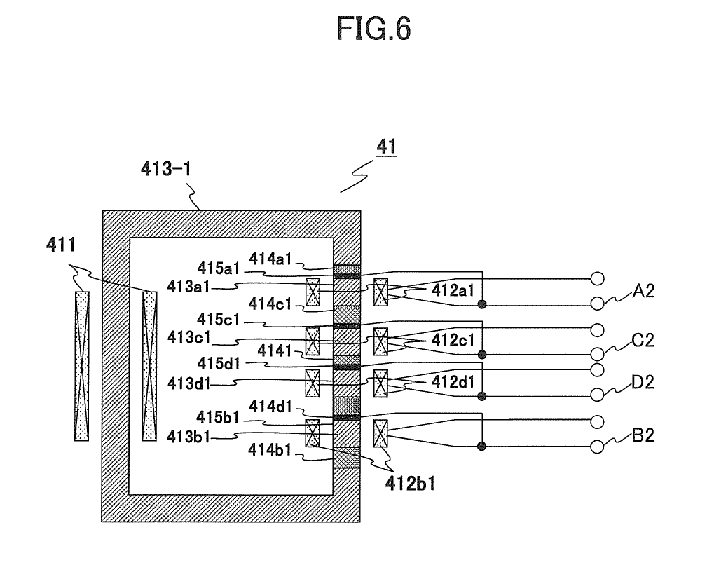

The third embodiment will be described using FIG. 6. A difference from the first or second embodiment is arrangement of the secondary windings 412a1 to 412d1 and the divided iron cores 413a1 to 413d1. That is, a maximum potential difference between the iron cores are reduced by arranging the respective iron cores so that iron cores whose potential difference is large are not adjacent each other.

Hereinafter, the difference from the second embodiment will be described mainly.

In a position adjacent to the iron core 413-1 whose potential is ground and around which the primary winding 411 is wound, the secondary windings 412a1 and 412b1 as well as the iron cores 413a1 and 413b1 that are close to the ground potential are arranged in the present embodiment. Also, in a position away from the iron core 413-1that is the ground potential, the secondary windings 412c1 and 412d1 as well as the iron cores 413c1 and 413d1 with high potentials are arranged. The specific arrangement is as shown in FIG. 6, and the iron cores 413-1, 413a1, 413c1, 413d1, and 413b1 are arranged in order along the magnetic flux direction of the iron core 413. That is, the respective iron cores having different potentials are arranged alternately from the outside in ascending order of potentials.

By disposing the iron core 413 as shown in the cross-sectional view of FIG. 6, potential differences are equal between the iron cores 413-1 and 413a1 as well as the iron cores 413c1 and 413d1, and potential differences are equal between the iron cores 413a1 and 413c1, the iron cores 413d1 and 413b1, as well as the iron cores 413b1 and 413-1. Additionally, the potential difference between the iron cores 413a1 and 413c1 are within twice the potential difference between the iron cores 413-1 and 413a1, which can reduce the electric field concentration. Also, equipotential lines around the secondary windings are approximately symmetrical in the magnetic flux direction.

According to the present embodiment, a maximum potential difference between the iron cores can be reduced compared to the second embodiment, and equipotential lines around the secondary windings are approximately symmetrical in the magnetic flux direction, which can reduce risk of insulation breakdown due to electric field concentration.

### Fourth Embodiment

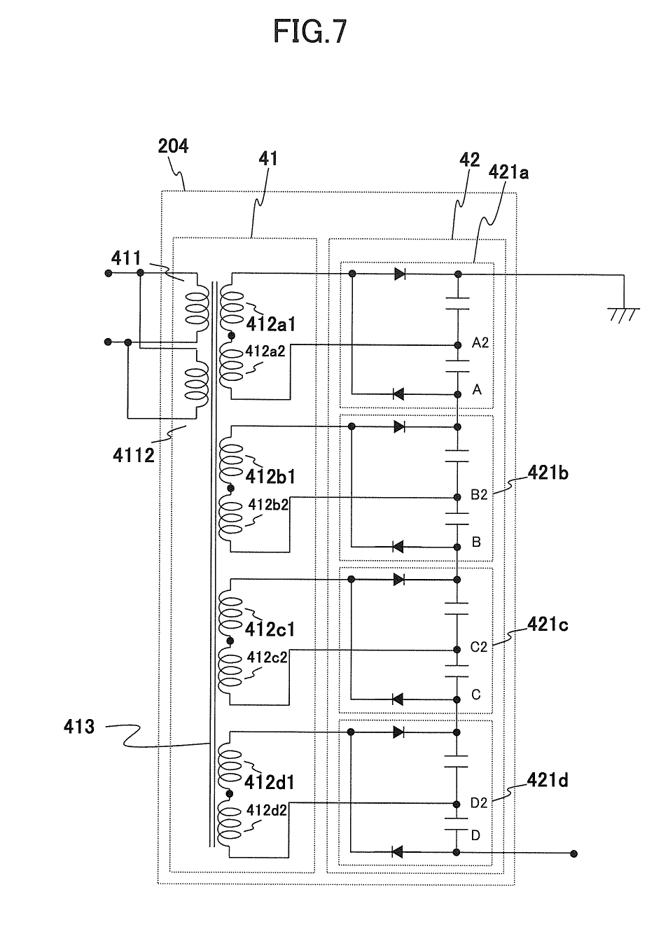

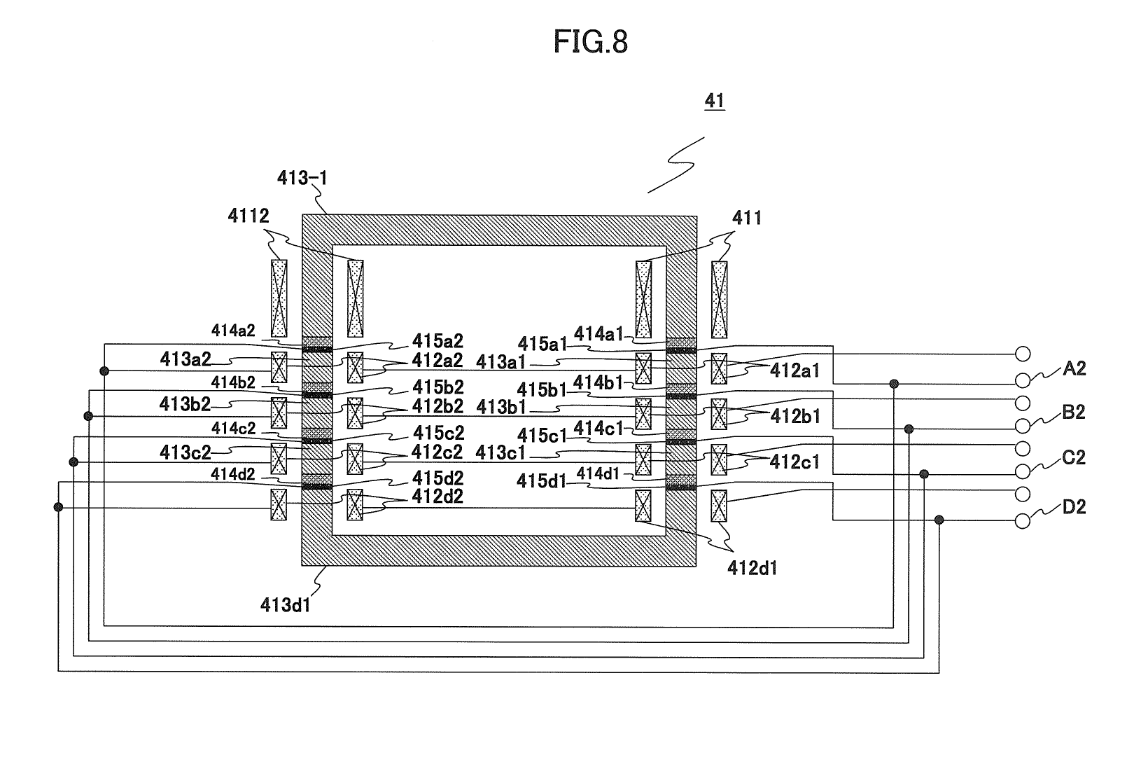

The fourth embodiment will be described using FIGS. 7 and 8. Differences from the second embodiment are that the primary winding 411 is divided and that each of the divided secondary windings 412a1 to 412d1 is further divided. Hereinafter, the difference from the second embodiment will be described mainly.

FIG. 7 shows a wiring configuration inside the high-voltage generator 204 of the present embodiment. Differences from FIG. 3 showing the wiring configuration of the second embodiment are that a primary winding of the high-voltage transformer 41 is divided in parallel into two and that an output of the inverter 203 is supplied to each of the primary windings 411 and 4112. Also, each of the divided secondary windings 412a1 to 412d1 are further divided in the serial direction, and 412a1 and 412a2, 412b1 and 412b2, 412c1 and 412c2, as well as 412d1 and 412d2 are connected in series respectively.

FIG. 8 is a cross-sectional schematic view showing the structure of the high-voltage transformer 41 of the present embodiment. Differences from FIG. 5 showing the structure of the second embodiment are that both the legs of the iron core 413 are divided in the magnetic flux direction and that the primary winding 411 and the secondary windings 412a1 to 412d1 as well as the primary winding 4112 and the secondary windings 412a2 to 412d2 are wound around both the legs respectively. Focusing on the secondary windings 412a1 and 412a2 as well as a circuit of the voltage doubler rectifying circuit 421a as an example in order to describe a winding structure of the present embodiment, the secondary windings 412a1 and 412a2 wound around both the legs of the iron core 413 are connected in series, and both the terminals connected serially are connected to the voltage doubler rectifying circuit 421a. The iron cores 413a1 and 413a2, around which the secondary windings 412a1 and 412a2 are wound, are connected to one terminal of the secondary winding 412a2 whose potential is a direct current and fixed to a potential A2. The iron core 413d1, around which the secondary windings 412d1 and 412d2 having the highest potential are wound, is not divided, and both the secondary windings 412d1 and 412d2 are wound around the same iron core 413d1.

According to the present embodiment, windings are wound around both the legs of the iron core 413 in a similar shape, which can configure a symmetrical high-voltage transformer. Also, potentials of both the windings are almost equal, which can shorten an insulation distance between both of them compared to the first to third embodiments.

That is, according to the present embodiment, a high-voltage transformer that is smaller in the horizontal direction can be configured, which can provide a high-voltage transformer with a smaller occupied volume.

### Fifth Embodiment

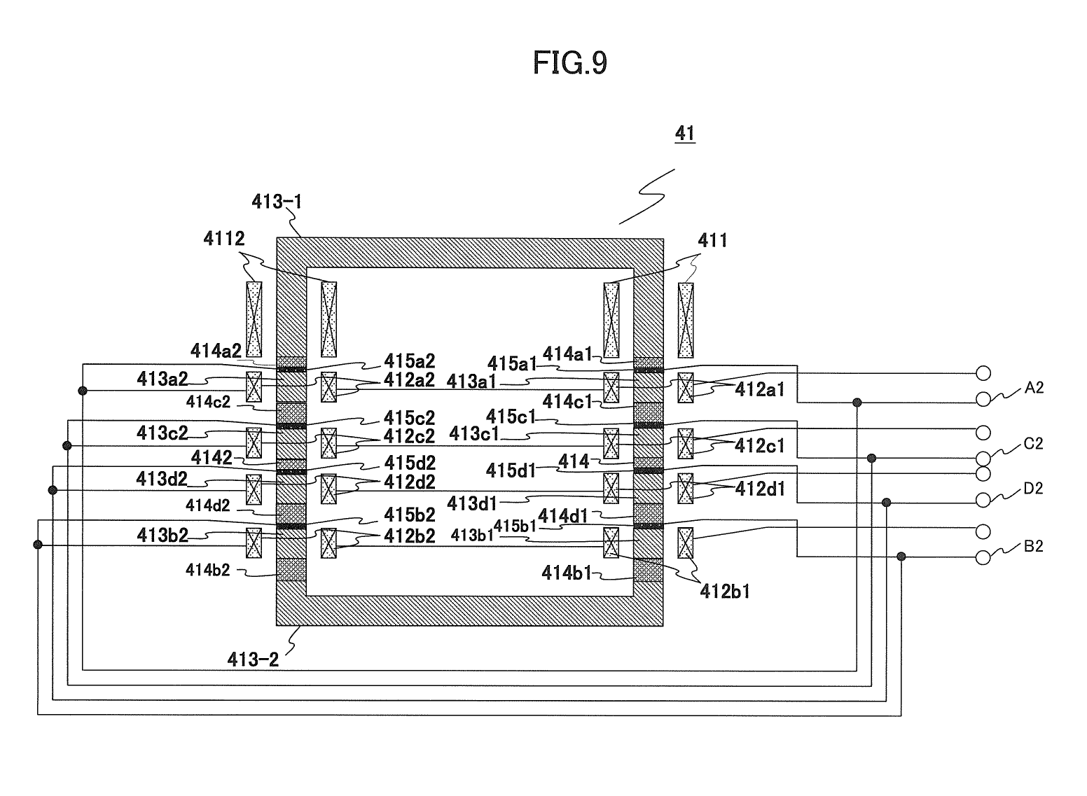

The fourth embodiment will be described using FIG. 9. In the present embodiment, the secondary windings 412a1 to 412d1 and 412a2 to 412d2 as well as the divided iron cores 413a1 to 413d1 and 413a2 to 413d2 of the fourth embodiment are arranged similarly to the third embodiment. Hereinafter, the difference from the fourth embodiment will be described mainly.

In a position adjacent to the iron core 413-1 whose potential is ground and around which the primary windings 411 and 4112 are wound, the secondary windings 412a1, 412b1, 412a2, and 412b2 as well as the iron cores 413a1, 413b1, 413a2, and 413b2 that are close to the ground potential are arranged in the present embodiment. Also, in a position away from the iron core 413-1that is the ground potential, the secondary windings 412c1, 412d1, 412c2, and 412d2 as well as the iron cores 413c1, 413d1, 413c2, and 413d2 with high potentials are arranged.

The iron core 413-2, around which a winding is not wound, may be set as a ground potential or may have the same potential as the other divided iron cores 413b1 and 413b2. Furthermore, the iron core 413-2 may not be divided.

Specifically, the iron core 413 has a structure shown in FIG. 9, and the iron cores 413-1, 413a1, 413c1, 413d1, 413b1, 413-2, 413b2, 413d2, 413c2 and 413a2 are arranged in order along the magnetic flux direction of the iron core 413. By disposing the iron core 413 as shown in the cross-sectional view of FIG. 9, the equipotential lines are horizontally symmetrical, and potentials of the left and right windings are approximately equal, which can shorten an insulation distance between both of them similarly to the fourth embodiment. Also, the exposed iron core 413-2 around which no winding is wound can be set to a low potential. Furthermore, electric field concentration can be reduced similarly to the third embodiment.

According to the present embodiment, similarly to the fourth embodiment, an occupied volume can be more reduced in the horizontal direction, a maximum potential difference between the iron cores can be reduced compared to the fourth embodiment, and equipotential lines around the secondary windings are approximately symmetrical in the magnetic flux direction, which can reduce risk of insulation breakdown due to electric field concentration. Consequently, a high-voltage transformer with a smaller occupied volume can be provided.

Also, because the iron core 413-1 is a ground potential and the iron core 413-2 is a ground potential or a relatively low potential, it is easy to fix a high-voltage transformer to a housing of the high-voltage generator 204 whose potential is ground.

### Sixth Embodiment

The sixth embodiment will be described using FIG. 10. Differences from the first to fifth embodiments are that one terminals of secondary windings are not connected to divided iron cores and that bobbins around which the secondary windings are wound are not insulators but a conductive material.

FIG. 10 is a cross-sectional view in which a part of a divided iron core is enlarged. The divided iron core 413b1 is electrically insulated from the other iron cores through the dielectrics 414a1 and 414b1. A secondary winding 412b1 is wound around a bobbin 417b of a conductive material and, in a case where a number of windings make layers, is configured using an insulating material 418b between the layers. Because the bobbin 417b of a conductive material is connected to one terminal whose potential is a direct current of the secondary windings 412b1, the potential is the same as one terminal B2 of the secondary windings 412b1. By configuring thus, a potential of the divided iron core 413b1 is equal to that of the bobbin 417b, which can prevent transitional electric field concentration caused by that the potential of the iron core 413b1 floats.

According to the present embodiment, a material of bobbins is only changed to a conductive material without providing an electrode with a divided iron core, which can achieve a simple configuration.

### Seventh Embodiment

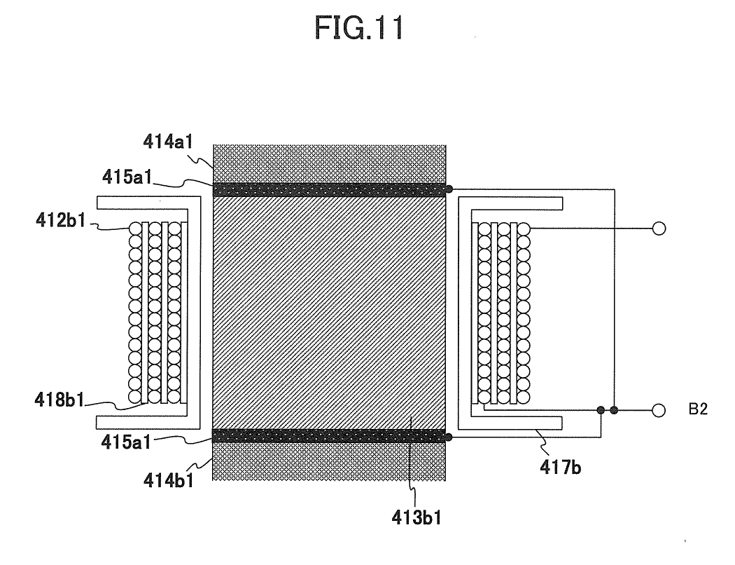

The seventh embodiment will be described using FIG. 11. A difference from the first to fifth embodiments is that the electrodes 415a1 are provided not only in one cross section orthogonal to the magnetic flux direction of the divided iron cores 412a1 to 413d1 and 413a2 to 413d2 but also in both of the cross sections.

FIG. 11 is a cross-sectional view in which a part of a divided iron core is enlarged. The electrodes 415a1 are provided in both of the cross sections of the divided iron core 413b1, and one terminal of the secondary windings 412b1 is connected to the electrode 415a1. By configuring thus, the divided iron core 413b1 is the same as a potential of the terminal B2. Also, in case of using a material with a high volume resistivity for the divided iron core 413b1, potentials of the divided iron cores can be more stabilized by equalizing the potentials in both of the cross sections of the divided iron cores.

### Eighth Embodiment

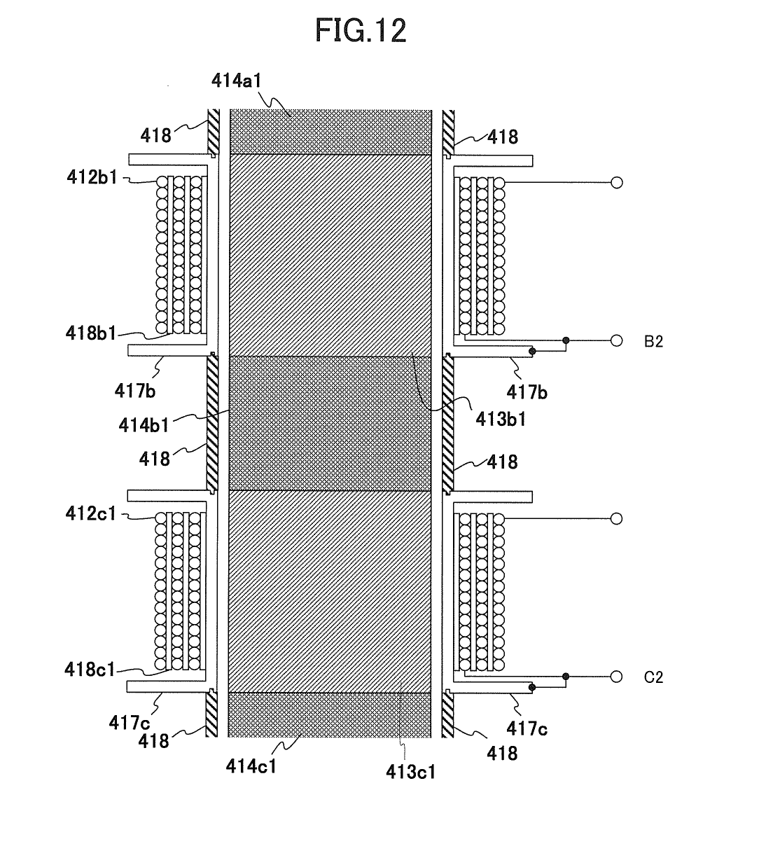

The eighth embodiment will be described using FIG. 12. A difference from the sixth embodiment is that bobbins are connected to each other.

FIG. 12 is a cross-sectional view in which iron cores, windings, and a part of bobbins are enlarged. The bobbins 417 around which the divided windings 412 are wound are connected using insulators 418. It is desirable that a member having the same physical property as insulating oil and made of PTFE is used for the insulators 418 for example. Also, the insulators 418 may be provided with holes to secure fluidity of the insulating oil filling the periphery of the iron core 413.

According to the present embodiment, compared to the sixth embodiment, divided windings can be handled as a group, which can improve productivity.

Additionally, although FIG. 12 shows only a secondary winding configuration, it may be configured so that a bobbin for the primary winding is further connected in a case where the primary and secondary windings are wound around the same leg of the iron core as shown in FIGS. 8 and 9.

### Ninth Embodiment

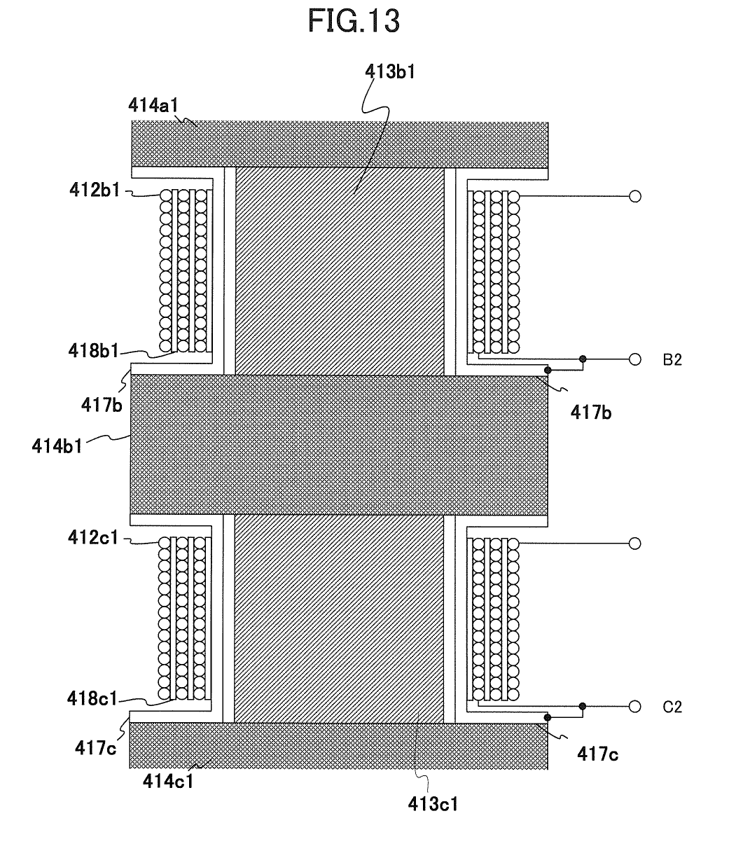

The ninth embodiment will be described using FIG. 13. A difference from the sixth embodiment is that the dielectrics 414 to be arranged between each iron core are larger than the iron cores 413 in a direction orthogonal to the magnetic flux.

FIG. 13 is a cross-sectional view in which iron cores, windings, and a part of bobbins are enlarged. The dielectrics 414 to be arranged between the iron cores 413 protrude from the iron cores 413 in the direction orthogonal to the magnetic flux. The bobbins 417 that are a conductive material are sandwiched between the dielectrics 414 protruding from the iron cores 413 from the magnetic flux direction. In the present embodiment, such a structure can simplify the support structure compared to the eighth embodiment and reduce the number of parts, which improves productivity.

Additionally, although FIG. 13 shows only a secondary winding configuration, it may be configured so that a bobbin for the primary winding is further connected in a case where the primary and secondary windings are wound around the same leg of the iron core as shown in FIGS. 8 and 9.

### Tenth Embodiment

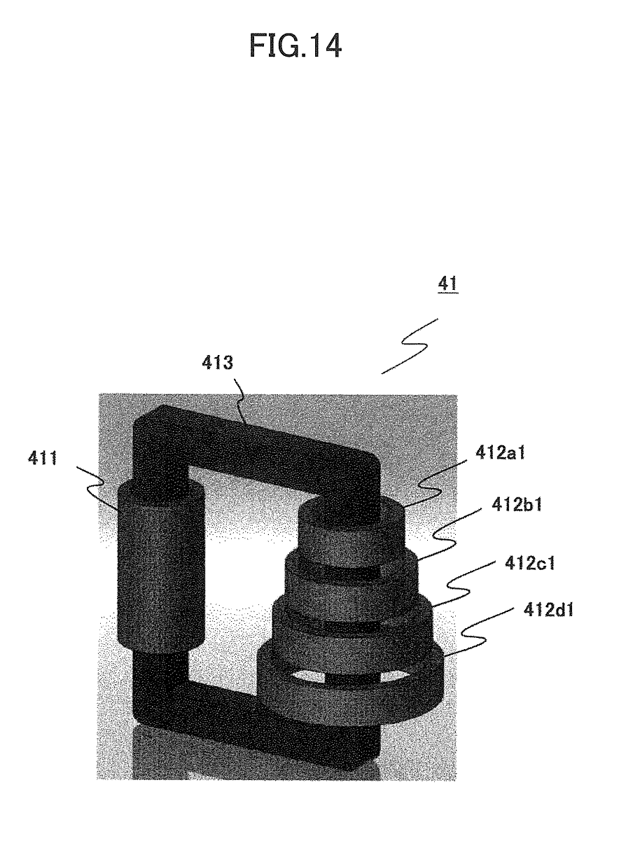

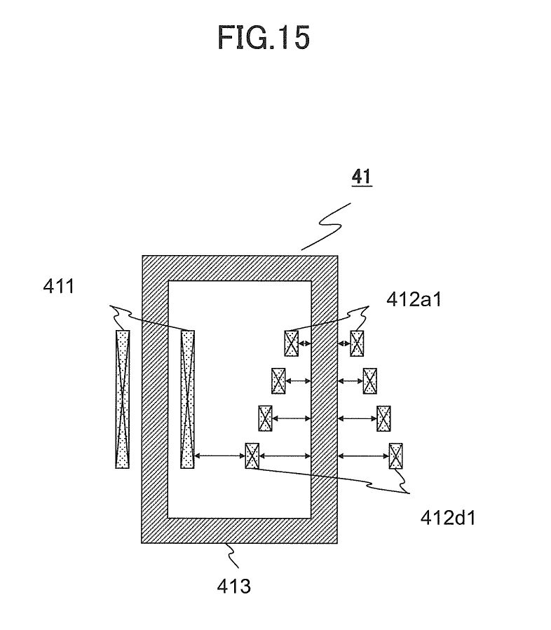

The tenth embodiment will be described using FIGS. 14 and 15. In the present embodiment, although the secondary winding is divided in the magnetic flux direction, the iron core is not divided. Also, the divided secondary windings have different potential differences respectively for the iron core, and distances between the iron core and each secondary winding are set according to the potential difference.

FIG. 14 is a perspective view of an essential part of the high-voltage transformer 41 of the present embodiment, and FIG. 15 is a cross-sectional view of FIG. 14. Similarly to the other embodiments, the primary winding 411 and the secondary windings 412 are wound around both the legs of the iron core 413. The secondary windings 412 are divided into four in the magnetic flux direction, and the respective secondary windings 412a1 to 412d1 are arranged in the magnetic flux direction. Also, the secondary windings 412a1 to 412d1 have different potentials respectively. That is, when the high-voltage transformer 41 outputs a voltage of 4V, the secondary windings 412a1 to 412d1 have potential differences of V, 2V, 3V, and 4V respectively for the iron core 413 whose potential is ground. In the present embodiment, according to the potential differences between the iron core 413 and the respective secondary windings 412a1 to 412d1, distances between both of them are set. For example, when a distance between the iron core 413 and the secondary winding 412a1 is d, distances between the iron core 413 and the other secondary windings 412b1 to 412d1 are set to 2d, 3d, and 4d respectively.

According to the present embodiment, although a distance is long between an iron core and a secondary winding having a high potential, distances are short between the iron core and the other secondary windings. This can provide a high-voltage generator including a high-voltage transformer miniaturized while insulation between the secondary windings and the iron core is maintained.

### Eleventh Embodiment

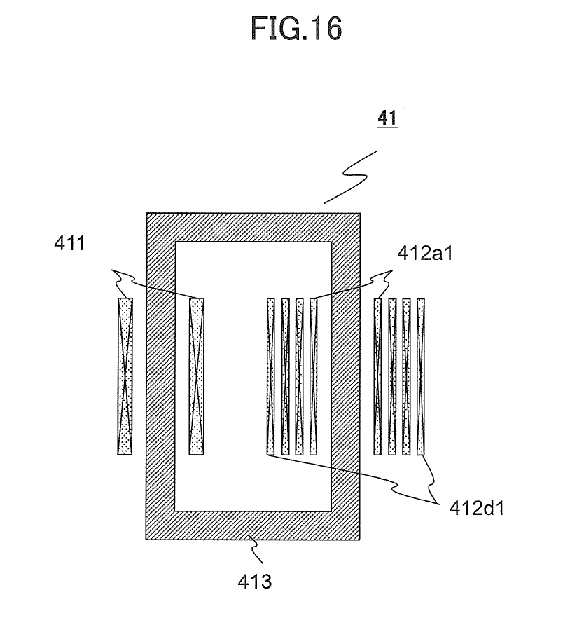

The eleventh embodiment will be described using FIG. 16. In the present embodiment, divided secondary windings are arranged concentrically. Because the divided secondary windings have different potential differences respectively for an iron core, distances between the iron core and each secondary winding are set according to the potential difference.

FIG. 16 is a cross-sectional schematic view showing the structure of the high-voltage transformer 41 of the present embodiment. The primary winding 411 and the secondary windings 412 are wound around both the legs of the iron core 413. The secondary windings 412 are divided into four, and the secondary windings 412a1 to 412d1 are arranged respectively in a direction orthogonal to the magnetic flux. The secondary windings 412a1 to 412d1 have different potentials respectively. That is, when the high-voltage transformer 41 outputs a voltage of 4V, the secondary windings 412a1 to 412d1 have potential differences of V, 2V, 3V, and 4V respectively for the iron core 413 whose potential is ground. In the present embodiment, according to the potential differences between the iron core 413 and the respective secondary windings 412a1 to 412d1, the secondary windings 412a1 to 412d1 are arranged respectively. For example, when a distance between the iron core 413 and the secondary winding 412a1 is d, the respective secondary windings are arranged concentrically so that distances between the iron core 413 and the other secondary windings 412b1 to 412d1 are set to 2d, 3d, and 4d respectively.

Compared to the tenth embodiment, the present embodiment prevents equipotential lines around the secondary windings are prevented from being complicated and can arrange the respective secondary windings compactly in the magnetic flux direction, which can provide a high-voltage generator including a high-voltage transformer miniaturized while insulation between the secondary windings and the iron core is maintained.

As described above, although various embodiments have been described, the present invention is not limited to these embodiments. For example, although a voltage doubler rectifying circuit is used for a high-voltage rectifier, it is apparent that a similar effect can be obtained also in a case where the high-voltage rectifier is multistage-serially configured using a rectifier circuit in which a smoothing condenser is built in a bridge-type rectifier circuit with four diodes combined and a step-up rectifier circuit such as a Cockcroft-Walton circuit.

### REFERENCE SIGNS LIST

1: X-ray CT apparatus

100: scan gantry unit

101: X-ray tube device

102: rotary disk

103: collimator

104: opening

105: bed device

106: X-ray detector

107: data collection device

108: gantry controller

109: bed controller

110: X-ray controller

120: operation console

121: input device

122: image processing device

123: storage device

124: system controller

125: display device

201: alternating current power source

202: converter

203: inverter

204: high-voltage generator

41: high-voltage transformer

42: high-voltage rectifier

411 and 4112: primary windings

412a1 to 412d1 and 412a2 to 412d2: secondary windings

413, 413-1, 413-2, 413a1 to 413d1, and 413a2 to 413d2: iron cores

414, 414a1 to 414d1, and 414a2 to 414d2: dielectrics

415a1 to 415d1 and 415a2 to 415d2: electrodes

416, 416a1 to 416d1, and 416a2 to 416d2: dielectrics (high resistors)

417b and 417c: bobbins

418: insulator

421a to 421d: voltage doubler rectifying circuits

1. A high-voltage generator comprising:
a high-voltage transformer that has a primary winding, secondary windings, and an iron core; and
a high-voltage rectifier that rectifies an alternating current voltage to be output from the high-voltage transformer into a direct current voltage,
wherein the secondary windings and the iron core are divided in the direction of a magnetic flux generated by applying an alternating current to the primary winding,
wherein the respective divided secondary windings are wound around the respective divided iron cores correspondingly, and
wherein dielectrics are disposed between the respective divided iron cores.

2. The high-voltage generator according to claim 1,
wherein the divided iron cores have electrodes on at least one of cross sections orthogonal to the magnetic flux direction, and
wherein the electrodes are electrically connected to one terminals of the respective divided secondary windings.

3. The high-voltage generator according to claim 1,
wherein the respective divided iron cores are arranged alternately from the outside in ascending order of potentials that the respective iron cores have.

4. The high-voltage generator according to claim 1,
wherein the iron core has two legs that are divided in the magnetic flux direction, and
wherein the primary winding and the respective divided secondary windings are wound around each leg.

5. The high-voltage generator according to claim 1,
wherein the respective bobbins around which the respective divided secondary windings are wound are electrical conductors,
wherein one terminals of the respective divided secondary windings are electrically connected to the bobbins.

6. The high-voltage generator according to claim 5,
wherein the respective bobbins are connected using insulators in the magnetic flux direction.

7. The high-voltage generator according to claim 5,
wherein the dielectrics disposed between the respective divided iron cores are larger than the respective iron cores in a direction orthogonal to the magnetic flux, and
wherein the respective bobbins are sandwiched by the dielectrics from the magnetic flux direction.

8. An X-ray scanning apparatus comprising:
an X-ray source that irradiates an X-ray to an object; and
a high-voltage generator that supplies electric power to the X-ray source,
wherein the high-voltage generator comprises a high-voltage transformer that has a primary winding, secondary windings, and an iron core as well as a high-voltage rectifier that rectifies an alternating current voltage to be output from the high-voltage transformer into a direct current voltage,
wherein the secondary windings and the iron core are divided in the direction of a magnetic flux generated by applying an alternating current to the primary winding,
wherein the respective divided secondary windings are wound around the respective divided iron cores correspondingly, and
wherein dielectrics are disposed between the respective divided iron cores.
